(19) United States
(12) Patent Application Publication
(10) Pub. No.: US 2016/0009226 A1
(43) Pub. Date: Jan. 14, 2016

(54) REAR-VIEW MIRROR ASSEMBLY FOR MOTOR VEHICLES

(71) Applicant: MAGNA MIRRORS HOLDING GMBH, Sailauf (DE)

(72) Inventor: Peter KREBS, Mömbris (DE)

(21) Appl. No.: 14/771,761

(22) PCT Filed: Jan. 27, 2014
(86) PCT No.: PCT/DE2014/200029

§ 371 Date: Aug. 31, 2015

(30) Foreign Application Priority Data
Mar. 1, 2013 (DE) 10 2013 203 531.4

(51) Int. Cl. B60R 1/08; G02F 1/1339; G02F 1/1333; G02F 1/1337

(52) U.S. Cl. CPC B60R 1/088; G02F 1/1337; G02F 1/1339; G02F 1/133308; B60R 2300/8066

(57) ABSTRACT

A rear-view mirror arrangement for a motor vehicle, having a housing to hold a mirror assembly which has a liquid-crystal cell, the reflectance of the mirror assembly being variable. The liquid-crystal cell has a transparent front-side carrier layer, a transparent rear-side carrier layer and, an electrically actuable liquid-crystal layer arranged between the carrier layers and held in a sealed-off fashion by way of a seal frame. A permanently clear optical image is produced for the vehicle occupant as a user, and the mirror arrangement has a low weight and is inexpensive to produce. This is achieved in that the housing is of unipartite form and permits frameless retention of the mirror assembly, and a housing gap between the housing element and the mirror assembly into which is fitted a seal for the sealed retention of the mirror assembly in the housing.

### CROSS-REFERENCE TO RELATED APPLICATIONS

The present application is a National Stage Application of PCT International Application No. PCT/DE2014/200029 (filed on Jan. 27, 2014), under 35 U.S.C. §371, which claims priority to German Patent Application No. DE 10 2013 203 531.4 (filed on Mar. 1, 2013), which are each hereby incorporated by reference in their respective entireties.

### TECHNICAL FIELD

The present invention relates to a rear-view mirror arrangement for motor vehicles.

### BACKGROUND

Rear-view mirror arrangements for motor vehicles have a reflective surface which affords a view of the following traffic. Commonly, rear-view mirror arrangements are additionally designed to be dimmable. In this way, during travel in darkness, glare from vehicles traveling behind is avoided. In the case of automatically dimmable rear-view mirror arrangements, light sensors measure or detect the difference in brightness between the area in front of the vehicle and the traffic area behind. The measurement values are then transmitted to evaluation and control electronics, and the reflective capability of the mirror arrangement is correspondingly changed. In this case, mirror assemblies are used which comprise optical cells. Said optical cells may for example be in the form of liquid-crystal cells. In the case of such mirror arrangements, the reflective capability can be changed through the application of an electric field.

Already known mirror arrangements having a liquid-crystal cell as an optical cell are composed substantially of a mirror assembly which is mounted in a housing. For this purpose, the housing has a receiving space which has a receiving opening in a forward direction. The housing furthermore normally has a frame element which, during the assembly process, holds the mirror assembly fixed with clamping action in the rim region. The optical cell of the mirror assembly is composed substantially of a front-side and rear-side transparent carrier layer, two transparent, electrically conductive layers, two alignment layers, and a liquid-crystal layer which is arranged centrally between the layers and which comprises a liquid-crystal medium. The liquid-crystal medium of the liquid-crystal layer is received in sealed fashion between the alignment layers by way of an encircling seal arranged at the rim side. The encircling seal is in this case realized by way of a ring-shaped layer of an adhesive material arranged at the rim side.

A mirror arrangement having an optical cell is known for example from U.S. Patent Publication No. 2004/0240029 A1. In the case of said mirror arrangement, the optical cell is held in the rear-view mirror housing by way of a frame element which engages over the rim region of the mirror assembly.

Temperature fluctuations or very high temperature loading may in this case result in an impairment of the seal of the optical cell. This can lead to an ingress of air into the liquid-crystal medium or to a loss of liquid crystals. This results in an impairment of the optical image produced by the mirror arrangement.

### SUMMARY

It is therefore an object of the present invention to further develop an automatically dimmable rear-view mirror arrangement for a motor vehicle having an optical liquid-crystal cell such that the rear-view mirror arrangement produces a permanently clear optical image for the vehicle occupant as a user, has a low weight, and is inexpensive to produce.

Said object is achieved by way of the features that include a rear-view mirror arrangement for motor vehicles, having a housing and a mirror assembly which is held in the housing, and which comprises a liquid-crystal cell for viewing following traffic, wherein the reflectance of the mirror assembly can be varied by way of a control device, the liquid-crystal cell having a transparent front-side carrier layer, a transparent rear-side carrier layer, which each comprise a transparent, electrically conductive layer and an alignment layer and, arranged between the carrier layers, an electrically actuable liquid-crystal layer which contains a liquid-crystal medium, and wherein the liquid-crystal layer is held in sealed-off fashion by way of a seal frame arranged between the carrier layers, the housing comprising a housing element which is of unipartite form and which permits frameless retention of the mirror assembly, and between the housing element and the mirror assembly there remains a housing gap into which there is fitted a seal for the sealed retention of the mirror assembly in the housing, and wherein the seal is an adhesive which is an epoxy or acrylate.

By way of the construction of the mirror assembly in accordance with embodiments, it is possible for an optically clear image to be permanently produced even in the event of temperature fluctuations and high temperature loading. This is achieved through the additional arrangement of a seal in a housing gap between housing and mirror assembly. Owing to the frameless retention of the mirror assembly in the housing, an improved appearance of the display for the user is realized. The width of the display is denoted in the figures by the dimension arrow D.

The production costs can be considerably reduced because the mirror assembly is held in the unipartite housing element by way of a seal, and additional clamping fixing of the mirror assembly by way of a frame element of the housing element can be omitted.

The seal is preferably realized by way of an adhesive film. The adhesive firstly realizes retention of the mirror assembly in the housing element and secondly realizes additional sealing. In this way, the disadvantages mentioned in the introduction are eliminated. During the production of the reflective elements/foil, the cut edge thereof is open and must normally be covered or sealed. Owing to the additional seal, said edge sealing of the mirror assembly can be dispensed with. This yields a considerable cost advantage. The housing element is of unipartite form, whereby the number of parts to be manufactured is reduced.

In a further embodiment according to the invention of the rear-view mirror arrangement, frameless fixing of the mirror assembly to the housing is provided.

Further advantageous embodiments and refinements of the rear-view mirror arrangement according to the invention will emerge from the subclaims.

### DRAWINGS

Preferred embodiments of the rear-view mirror arrangement for a motor vehicle will be described by way of example below, wherein for illustrative purposes, reference is made to the appended drawings, in which:

FIG. 1 shows a schematic view of a rear-view mirror arrangement as an interior mirror arrangement,

FIG. 2 shows a cross section of a mirror arrangement in a first embodiment,

FIG. 2.1 shows a cross section of a mirror arrangement in a second embodiment,

FIG. 3 shows a cross section of a mirror arrangement in a third embodiment; and

FIG. 3.1 shows a cross section of a mirror arrangement in a fourth embodiment.

### DESCRIPTION

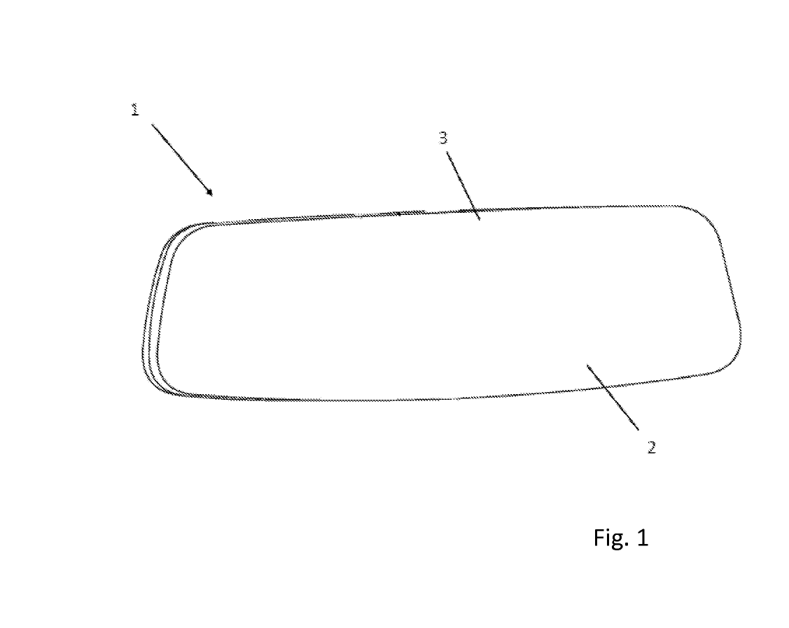

FIG. 1 shows, in a schematic illustration in a front view, a rear-view mirror arrangement for installation in a motor vehicle. A mirror assembly 2 by way of which the following traffic can be viewed is, in a first refinement, held on a housing 3 in an enclosed manner on a carrier plate 3a in the form of a housing element. The housing element 3a has, for this purpose, a receiving space which, in a forward direction, has a receiving opening. The housing element 3a is of unipartite form and permits frameless retention of the mirror assembly 2. The housing 3 with housing element 3a can normally be fixed by way of a holding device/mirror foot to the interior compartment, that is to say to the vehicle roof lining or to the windshield of a motor vehicle. Also installed in the housing 3 of the interior rear-view mirror is at least one light sensor by way of which the light intensity of the surroundings from the direction of the following traffic is detected. Furthermore, the light intensity of the area in front of the vehicle is detected. Actuation, and dimming, of the mirror assembly 2 is then effected in a manner dependent on the measured signals. The rear-view mirror arrangement 1 may self-evidently also be in the form of an exterior mirror.

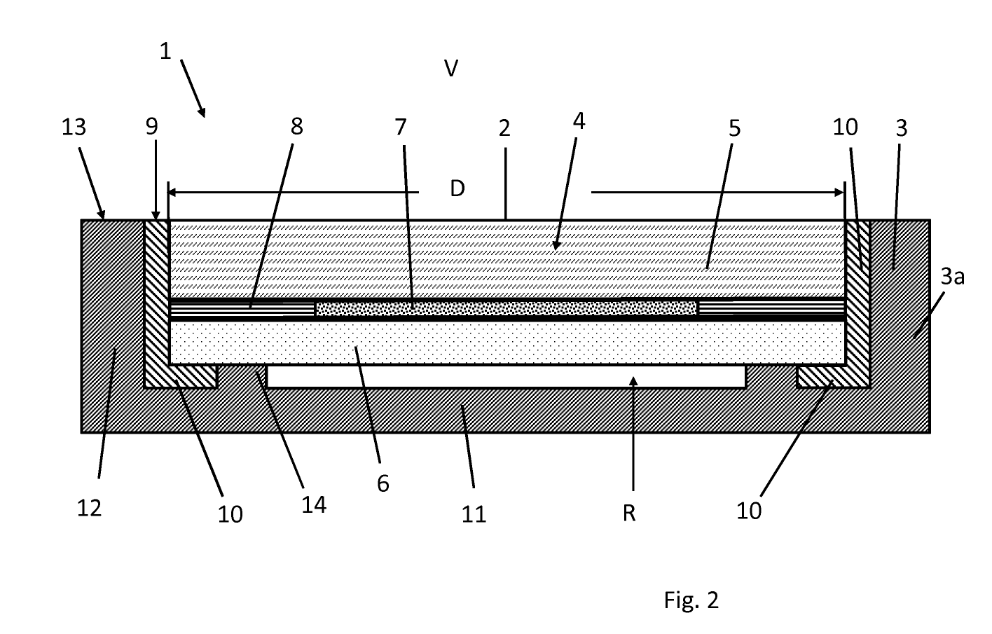

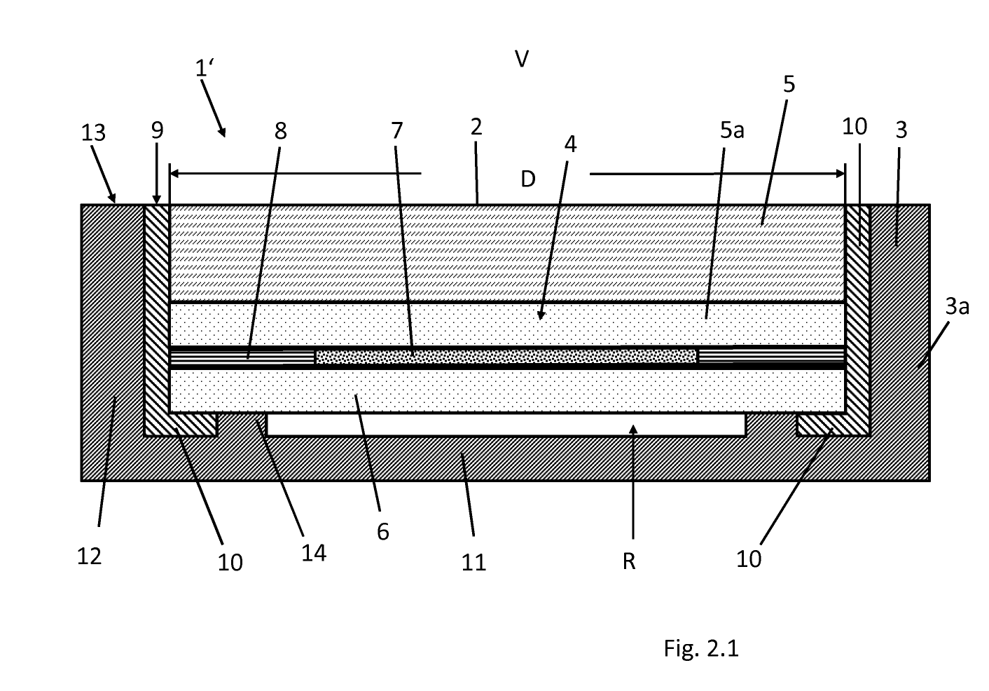

A first embodiment of a mirror arrangement 1 according to the invention, which is equipped with an automatic dimming function, will be described below on the basis of FIG. 2. The sensors that detect the light intensity, and the actuation electronics and evaluation electronics will not be illustrated or described in any more detail here. These are known to a person skilled in the art from the prior art. The optical cell is not illustrated true to scale, and is not illustrated in its entirety. The basic construction and function are likewise known to a person skilled in the art from the prior art.

For varying the reflectance, the mirror assembly 2 according to the invention comprises a liquid-crystal cell 4 which has a transparent front-side carrier layer 5, a transparent rear-side carrier layer 6 and, arranged between the carrier layers 5, 6, an electrically actuable liquid-crystal layer 7 which contains a liquid-crystal medium. In the case of this liquid crystal-based technology, use is made of the effect that, when an electric field is applied to the liquid-crystal cell 4, the liquid-crystal molecules align themselves parallel to the electric field. In the basic state, that is to say without an electric field, the liquid-crystal molecules are aligned in the longitudinal direction, that is to say the direction in which light passes through. To realize said alignment, alignment layers are provided.

As already described in the introduction, the mirror assembly 2 is mounted in a unipartite housing element 3a, referred to as carrier plate, such that frameless retention of the mirror assembly 2 is permitted. In this case, between the housing element 3a and the mirror assembly 2, there remains a housing gap 9 into which, during the assembly of the mirror arrangement 1, there is fitted a seal 10 for the sealed retention of the mirror assembly 2 in the housing element 3a. The seal 10 is in this case preferably an adhesive (for example epoxy or acrylate).

For the receiving of the mirror assembly 2 in the housing element 3a, the housing element 3a is formed as a housing half-shell composed preferably of a plastics material, said housing half-shell comprising a housing base 11 and an encircling housing rim 12 with a face surface 13 pointing toward the front side V. In this case, the housing base 11 and housing rim 12 form the receiving space, which is open in the forward direction, for the mirror assembly 2. The housing base 11 is formed with bearing points 14 for supporting the mirror assembly 2. Said bearing points 14 are, for example, in the form of web-shaped bearing points 14.

As can be seen from FIG. 2, the mirror assembly 2 is held in the housing element 3a such that the transparent front-side carrier layer 5, the seal 10 and the face side 13 of the housing rim 12 are aligned flush with one another. The seal 10 is fitted into the encircling housing gap 9 so as to completely close off the housing gap 9 between the housing inner wall and the mirror assembly in sealing fashion.

The liquid-crystal cell 4 or optical cell of the mirror assembly is composed substantially of the construction described below. A liquid-crystal layer 7 which comprises a liquid-crystal medium is arranged in sealed fashion between two transparent, electrically conductive layers. The contacting of said areal electrodes is not illustrated. Furthermore, between the electrically conductive layers and the liquid-crystal layer 7, there is provided in each case one layer which effects an alignment of the liquid-crystal molecules in the basic state (when an electric field is not applied). Said layers are referred to as alignment layers, which are likewise of transparent form. The liquid crystals of the liquid-crystalline medium of the liquid-crystal layer 7 are received in sealed fashion between the alignment layers by way of an encircling seal 8 arranged at the rim side. The encircling seal will hereinafter be referred to as seal frame 8, and can be realized by way of a ring-shaped layer of an adhesive material arranged at the rim side.

The above-described layer arrangement with liquid-crystal layer 7 is arranged between two transparent carrier layers 5, 6. As viewed from the front side V of the rear-view mirror arrangement, the transparent carrier layer 5 is in the form of a glass layer and is referred to as front-side carrier layer. The glass layer has the function of an anti-scratch protector. As further material for the transparent carrier layer 5 arranged on the front side, use may also be made of a transparent foil or plastics plate. On the side pointing toward the housing base 11, the transparent carrier layer 6 is referred to as rear-side carrier layer and may be in the form of a transparent foil, plastics plate or glass.

The rear-side carrier layer 6 is provided, on the side pointing toward the housing base 11, with a non-transparent, reflective layer 13. The non-transparent, reflective layer may in this case be composed of a metallic coating. Said layer is produced for example by vapor deposition or sputtering or spraying. The reflective layer is not illustrated in the drawing.

In summary, the layer construction of the mirror assembly 2, proceeding from the front side of the rear-view mirror arrangement 1, is listed below:
transparent carrier layer
electrically conductive layer
alignment layer
liquid-crystal layer with liquid-crystal medium and seal frame
alignment layer
electrically conductive layer
transparent carrier layer
reflective layer or semi-transparent reflective layer

In a further embodiment which is not illustrated, by contrast to the embodiment of the mirror assembly 2 described above, the reflective layer is in the form of a semitransparent reflective coating. This permits the additional arrangement of a display arrangement on the rear side of the mirror assembly 2.

FIG. 2.1 shows a first alternative embodiment of the rear-view mirror arrangement 1′. Here, the same reference signs are used to denote identical parts. For simplicity, these will not be described. By contrast to the embodiment shown in FIG. 2, the mirror assembly 2 comprises a further transparent layer. Said transparent layer 5a is arranged between the transparent carrier layer 5 and the electrically conductive layer. The additional transparent layer 5a is preferably a transparent foil.

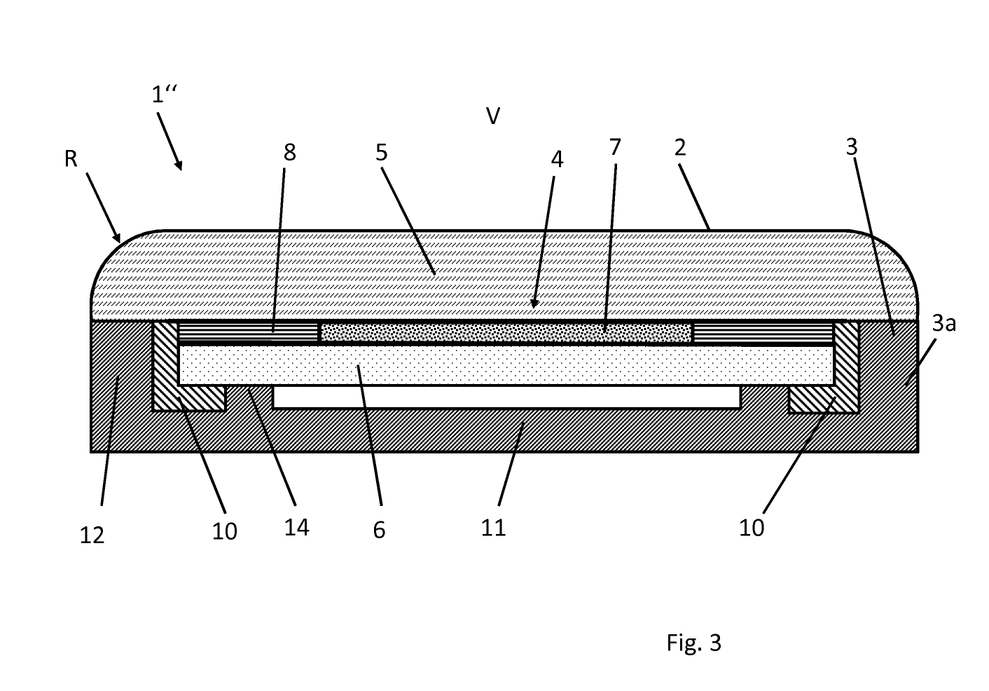

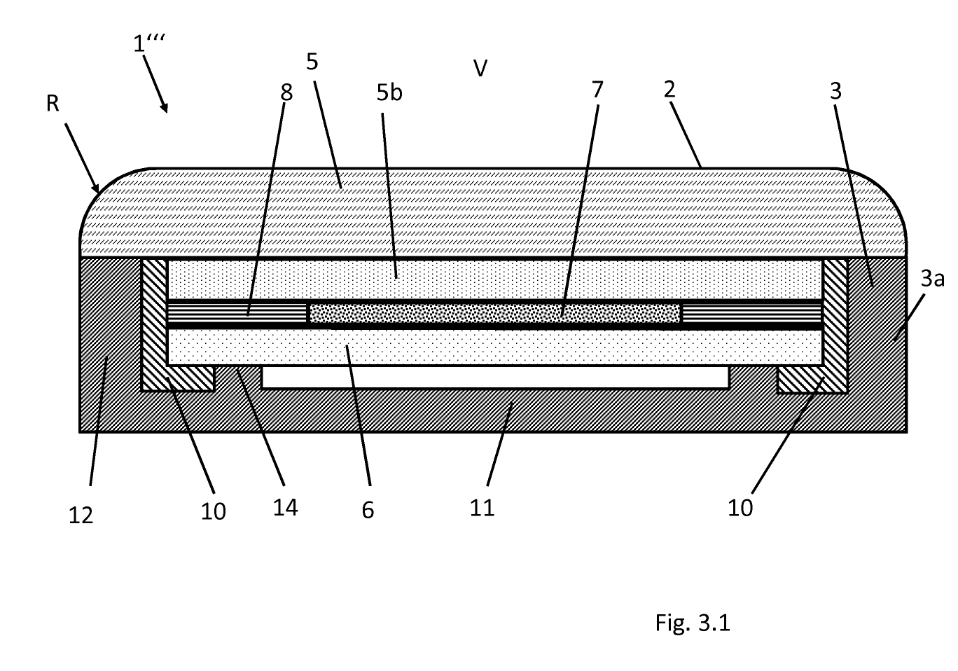

The embodiment illustrated in FIG. 3 shows an alternative embodiment of a rear-view mirror arrangement 1″ according to the invention. Here, identical parts are denoted by the same reference signs. By contrast to the mirror assembly 2 described in

FIG. 2, the mirror assembly 2 is held in the housing 3 such that the transparent front-side carrier layer 5 covers the face side 13 of the housing rim 12 and terminates flush with the outer contour 3a of the housing half-shell. The encircling forward-pointing rim region R of the transparent front-side carrier layer 5 is in this case of rounded form.

Furthermore, FIG. 3.1 illustrates a fourth alternative embodiment. In this case too, identical parts are denoted by the same reference signs. By contrast to the embodiment illustrated in FIG. 3, an additional transparent layer 5b is provided here. Said transparent layer 5b is arranged between the transparent carrier layer 5 and the electrically conductive layer. The additional transparent layer 5b is preferably a transparent foil.

1-8. (canceled)

9. A rear-view mirror arrangement for a motor vehicle, comprising:
a housing having a housing element which is of unipartite form;
a mirror assembly framelessly held in the housing by the housing element, the mirror assembly having a variable and controllable reflectance, and a liquid-crystal cell having:
a front-side carrier layer that is composed as a first transparent, electrically conductive layer and a first alignment layer,
a rear-side carrier layer that is composed as a second transparent, electrically conductive layer and a second alignment layer,
an electrically actuable liquid-crystal layer arranged between the front-side carrier layer and the rear-side carrier layer, the electrically actuable liquid-crystal layer containing a liquid-crystal medium, and
a seal frame to hold the liquid-crystal layer in sealed-off fashion, the seal frame being arranged between the front-side carrier layer and the rear-side carrier layer,
a housing gap between the housing and the mirror assembly; and
a seal fitted into the housing gap for a sealed retention of the mirror assembly in the housing, the seal composed of an adhesive which is an epoxy or acrylate.

10. The rear-view mirror arrangement of claim 9, wherein the housing element comprises a housing half-shell having a housing base and an encircling housing rim with a face surface pointing toward a front side of the rear-view mirror arrangement.

11. The rear-view mirror arrangement of claim 10, wherein the seal is fitted in a manner so as to extend from an upper edge of the housing rim into a rim region between the housing base and a lower side of the mirror assembly.

12. The rear-view mirror arrangement of claim 10, wherein the housing base comprises bearing points to support the mirror assembly.

13. The rear-view mirror arrangement of claim 10, further comprising a ring-shaped web proceeding from an upper end region of the housing rim of the housing element, the ring-shaped web extending radially in a manner so as to form a receiving space of the housing element, and the housing gap remains between the mirror assembly, the ring-shaped web, the housing rim and the housing base.

14. The rear-view mirror arrangement of claim 9, wherein the mirror assembly is held in the housing element in a manner such that the transparent front-side carrier layer, the seal and the face side of the housing rim are aligned flush with one another.

15. The rear-view mirror arrangement of claim 9, wherein the mirror assembly is held in the housing element in a manner such that the transparent front-side carrier layer covers the face side of the housing rim and terminates flush with an outer contour of the housing element.

16. The rear-view mirror arrangement of claim 9, wherein the transparent front-side carrier layer is in the form of an optically transparent foil, glass plate or transparent plastics plate.

17. The rear-view mirror arrangement of claim 9, wherein the transparent rear-side carrier layer is in the form of an optically transparent foil, glass plate or transparent plastics plate.

18. A rear-view mirror arrangement for a motor vehicle, comprising:
a housing having a housing base and an encircling housing rim with a face surface, the housing base and the housing rim forming a receiving space;
a mirror assembly framelessly held in the receiving space, the mirror assembly having a liquid-crystal cell having:
a first transparent layer that is composed of an electrically conductive material,
a second transparent layer that is composed of an electrically conductive material,
a third transparent layer that is composed of an electrically conductive material,
an electrically actuable liquid-crystal layer arranged between the second carrier layer and the third carrier layer, the electrically actuable liquid-crystal layer containing a liquid-crystal medium, and
a seal frame arranged between the first carrier layer and the second carrier layer to hold the liquid-crystal layer in sealed-off fashion,
a housing gap between the housing and the mirror assembly; and
a seal fitted into the housing gap for a sealed retention of the mirror assembly in the housing.

19. The rear-view mirror arrangement of claim 18, wherein the housing element comprises a housing half-shell having a housing base and an encircling housing rim with a face surface pointing toward a front side of the rear-view mirror arrangement.

20. The rear-view mirror arrangement of claim 19, wherein the seal is fitted in a manner so as to extend from an upper edge of the housing rim into a rim region between the housing base and a lower side of the mirror assembly.

21. The rear-view mirror arrangement of claim 19, wherein the housing base comprises bearing points to support the mirror assembly.

22. The rear-view mirror arrangement of claim 19, further comprising a ring-shaped web proceeding from an upper end region of the housing rim of the housing element, the ring-shaped web extending radially in a manner so as to form a receiving space of the housing element, and the housing gap remains between the mirror assembly, the ring-shaped web, the housing rim and the housing base.

23. The rear-view mirror arrangement of claim 18, wherein the mirror assembly is held in the housing element in a manner such that the transparent front-side carrier layer, the seal and the face side of the housing rim are aligned flush with one another.

24. The rear-view mirror arrangement of claim 18, wherein the mirror assembly is held in the housing element in a manner such that the transparent front-side carrier layer covers the face side of the housing rim and terminates flush with an outer contour of the housing element.

25. The rear-view mirror arrangement of claim 18, wherein the transparent front-side carrier layer is in the form of an optically transparent foil, glass plate or transparent plastics plate.

26. The rear-view mirror arrangement of claim 18, wherein the transparent rear-side carrier layer is in the form of an optically transparent foil, glass plate or transparent plastics plate.

27. A rear-view mirror arrangement for a motor vehicle, comprising:
a housing having a housing base and an encircling housing rim with a face surface, the housing base and the housing rim forming a receiving space;
a mirror assembly framelessly held by the housing, the mirror assembly having a liquid-crystal cell having:
a first transparent layer that is composed of an electrically conductive material and which covers the face surface of the housing rim and terminates flush with an outer contour of the housing rim,
a second transparent layer that is composed of an electrically conductive material and which is arranged in the receiving space,
an electrically actuable liquid-crystal layer arranged in the receiving space between the second carrier layer and the third carrier layer, the electrically actuable liquid-crystal layer containing a liquid-crystal medium, and
a seal frame arranged in the receiving space between the first carrier layer and the second carrier layer to hold the liquid-crystal layer in sealed-off fashion,
a housing gap between the housing and the mirror assembly; and
a seal fitted into the housing gap for a sealed retention of the mirror assembly in the housing.
